(19) United States
(12) Patent Application Publication
(10) Pub. No.: US 2014/0112480 A1
(43) Pub. Date: Apr. 24, 2014

(54) METHOD FOR CAPTURING AND PLAYBACK OF SOUND ORIGINATING FROM A PLURALITY OF SOUND SOURCES

(71) Applicants: Remi Audfray, San Jose, CA (US); Maureen Dubois, Foster City, CA (US); Abe Weston, Fremont, CA (US)

(72) Inventors: Remi Audfray, San Jose, CA (US); Maureen Dubois, Foster City, CA (US); Abe Weston, Fremont, CA (US)

(73) Assignee: DOLBY LABORATORIES LICENSING CORPORATION, San Francisco, CA (US)

(21) Appl. No.: 14/124,116

(22) PCT Filed: Jun. 4, 2012
(86) PCT No.: PCT/US2012/040653

§ 371 Date: Dec. 5, 2013

Related U.S. Application Data
(60) Provisional application No. 61/497,182, filed on Jun. 15, 2011.

(51) Int. Cl. H04S 7/00

(52) U.S. Cl. CPC H04S 7/00
USPC 381/17

(57) ABSTRACT

The invention discloses a method for capturing and for play-back of sound originating from a plurality of sources. It also includes a computer program product having an audio file adapted to receive and play back such sound. Basically, sound originating from each sound source is recorded on individual tracks. To preserve the spatial distribution and the movement of the sound sources, the current positions of the sound sources are also recorded relative to at least one listening position. Furthermore, movements of one or more listeners during playback can be tracked and used for rendering the spatial acoustic field during playback tailored to the current position of the listener(s).

### CROSS-REFERENCE TO RELATED APPLICATIONS

This application claims priority to U.S. Patent Provisional Application No. 61/497,182, filed 15 Jun. 2011, hereby incorporated by reference in its entirety.

### FIELD OF INVENTION

The invention relates to a method for capturing sound originating from a plurality of sound sources. Furthermore, it relates to a method for playback of such sound, and a computer program product including an audio file adapted to receive such sound.

### BACKGROUND OF INVENTION

So-called surround sound may dramatically increase the listening experience of an audience. Especially in a movie theater or video gaming environment, the audience regularly expects overwhelming visual and audio quality. Surround sound significantly contributes to meeting such expectations by adding increased spatial resolution to the audio track during playback.

PRIOR ART

Surround sound includes a range of techniques such as for enriching the sound reproduction quality of an audio source with audio channels reproduced via additional, discrete speakers. Surround sound is characterized by a listener location or sweet spot where the audio effects work best, and presents a fixed or forward perspective of the sound field to the listener at this location. The multichannel surround sound application encircles the audience with a fixed number of surround channels (e.g. left-surround, right-surround, back-surround), as opposed to a “screen channels” only setup (center, front left, front right).

The prior art 7.1 surround speaker configuration introduces two additional rear speakers compared to the conventional 5.1 arrangement, for a total of four surround channels and three front channels.

Surround sound is created in several ways. The first and simplest method is using a surround sound recording microphone technique, and/or mixing-in surround sound for playback on an audio system using speakers encircling the listener to play audio from different directions. A second approach is processing the audio with psychoacoustic sound localization methods to simulate a two-dimensional sound field with headphones or a pair of speakers.

In most cases, surround sound systems rely on the mapping of each source channel to its own loudspeaker. Matrix systems recover the number and content of the source channels and apply them to their respective loudspeakers. With discrete surround sound, the transmission medium allows for (at least) the same number of channels of source and destination.

The transmitted signal might encode the information (defining the original sound field) to a greater or lesser extent; the surround sound information is rendered for replay by a decoder generating the number and configuration of loudspeaker feeds for the number of speakers available for replay.

As stated earlier, surround sound is usually tailored to delivery at a dedicated listener location (“sweet spot”) where the audio effects work best. The further away a listener gets from such sweet spot, the less impressive the audio perception gets.

There are also solutions to compensate for such movement of the listener and consequently adjusting the sound field to be reproduced. Such solutions usually include a position tracking sensor. Known commercial products usable in audio enhancement applications include Kinect for Microsoft XBOX or Trinnov Audio's Optimizer MC. Trinnov Audio developed a mathematical model to represent an acoustic field using Fourier-Bessel decomposition. They also developed a software/hardware tool to measure the acoustic field generated by feeding a multichannel signal into a playback system and save it into a radiation matrix. They implemented a solution that re-maps the multichannel signal so the sound from each channel appears to come from where the speaker for that channel is supposed to be. This solution also includes time and frequency correction for each speaker.

The following patent documents also disclose approaches to track a listener's position and adjust sound reproduction accordingly: US20070116306A1, U.S. Pat. No. 7,492,915B2, CN101453598A, US20080130923A1, and US20090304205A1.

### SUMMARY OF INVENTION

It is an object of the invention to further improve surround sound perception by providing methods for capturing and playback of sound originating from a number of sound sources, including listening position-dependent playback, e.g. via a fixed loudspeaker arrangements or via headphones.

Specifically, the proposed invention aims to offer improved usability on different playback system configurations.

It is yet another object of the invention to propose a new audio file format.

The object with regard to capturing sound is achieved by a method for capturing sound originating from a plurality of sound sources, the method comprising:
providing an individual recording track for each sound source to be recorded;
recording sound originating from each sound source on the individual recording track associated with said sound source;
repeatedly determining a current position for each sound source relative to at least one listening position;
storing each determined current position; and
associating each stored current position with the respective recorded sound.

Instead of encoding sound in a fixed number of channels, the suggested method captures sound based on individual sources present e.g. in a room. It records the sound of each source along with some metadata on individual tracks. Metadata may e.g. include spherical coordinates of the sound source relative to one or more listening positions as well as information about the current acoustic environment (reverberation time, early lateral reflections etc.).

The proposed method according to the invention provides for automatically adapting the sound to at least one listener's location based on the position information, thus allowing for increased flexibility regarding speaker choice and placement. Moreover, studio overhead can be largely reduced as it is no longer necessary to issue separate mixes for cinemas, Imax theaters, broadcast, 5.1 DVDs, 7.1 Blu-Ray Discs etc. The studio will simply create one mix common for various playback situations. This mix which will be encoded and then decoded in the destination playback system to render substantially the same acoustic field as was heard in the studio by the engineers or producers. The suggested sound rendering technology will also help the mix better translate from one playback system to another, providing a more consistent output to an end-user: The perception of the (movie) sound will be the same to the listener whether e.g. in a commercial cinema, or at home. Furthermore, the sound experience can be the same regardless where the listener is sitting in the room.

In a conventional cinema environment, the sound system is usually calibrated (e.g. with regard to equalization, time and level alignment) based on a spatial average over the entire audience. This results in a suboptimal experience as you cannot optimally calibrate the system for every seat, i.e. listener position, at the same time. The proposed method, however, can automatically adapt to the occupancy of the theater. If, for example, only ten seats are occupied as tracked by a sensor, the decoder of the destination playback system may switch to a (preset) setting optimized just for the occupied seats, leading to a better performance.

With increasingly cheaper and bigger media storage available, it makes sense to use separate channels for each sound source rather than adding more speaker channels.

In a further embodiment, at least one further recording track is provided for recording sound originating from at least one further sound source, wherein the further sound source is not specified regarding its position. This extra channel(s) may be used e.g. for capturing background sounds which appear to come from everywhere (e.g. the sound of crickets if the movie scene takes place in the south of France) to enhance the sound experience.

As already indicated earlier, recording the sound on the individual recording tracks preferably includes encoding the recorded sound, and each determined current position is represented by metadata associated with said encoding. In such embodiment, available storage or transmission channel capacity is properly taken care of by choosing and/or developing an appropriate encoder to maximize sound quality based on the available capacity. The metadata in this embodiment are part of or associated with the chosen encoding process and include the repeatedly determined current positions for each sound source relative to at least one listening position.

The object with regard to the playback of sound is achieved by a method for playback of recorded sound associated with a plurality of sound sources, the method comprising:
providing an audio file, wherein the audio file comprises: a number of recording tracks, each recording track having recorded sound originated from one of the sound sources, and repeatedly stored positions associated with the sound sources, the stored positions representing a movement profile of the sound sources relative to at least one listening position;
providing an audio playback system including a number of playback channels, wherein the playback system includes a computing unit programmed to generate a spatial acoustic field based on the recorded sounds and repeatedly stored positions included in the audio file; and
playback of the spatial acoustic field on the audio playback system.

In the playback system, the audio signal is decoded rendering the acoustic field—captured in the recording process including the repeatedly stored current positions—in the listening room. It differs from existing Fourier-Bessel based models by rendering the acoustic field from moving sound sources instead of fixed channels. The reference radiation matrix, for example as used by Trinnov Audio to represent the transfer functions between the multichannel signals and the acoustic field corresponding to the same sound environment, is replaced by a dynamically generated matrix representing the transfer functions between the source signals and the acoustic field corresponding to the intended sound environment, including the current position(s) of the listener(s). Similarly, the decoding matrix, for example as used be Trinnov Audio to represent the transfer functions between the acoustic field and the multi-channel signal feeding the loudspeakers, is replaced by a dynamically generated matrix adapting based on the number of listener(s) and their location.

Limited only by the acoustic properties of the playback system and environment, the proposed methods can optionally add acoustic enhancements such as reverberation tail or synthesized lateral reflections. The later will improve the Lateral Energy Fraction (LF) and Interaural Cross-correlation (IACC), which have been proven to be closely related to the subjective sense of envelopment as well as the Apparent Source Width (ASW).

Preferably, generation of the spatial acoustic field is adapted to the number of the playback channels. In such embodiment, playback is optimized to the properties of the playback system during playback, not already during the mixing stage. It is therefore no longer necessary to prepare a variety of different mixes tailored to specific playback systems and their channel set up.

A position change of one or more listeners can be tracked during playback via a sensor adapted to track a current position of the at least one listener. Such sensor may include an infrared laser projector and a monochrome CMOS sensor for capturing video data in 3D under any ambient light. It may also include an RGB camera and an infrared depth sensing laser.

Generation of the spatial acoustic field therefore preferably includes adapting the repeatedly stored positions to the tracked current position of the at least one listener to compensate for a movement of the respective listener(s) relative to the at least one listening position.

This can be advantageously accomplished by selecting correction information from a previously stored correction information matrix, the selected correction information associated with the currently tracked position of the at least one listener.

In that regard, the previously stored correction information matrix may include previously stored correction information related to a number of possible or anticipated positions of the listener in the playback environment. During playback, the currently tracked position of the at least one listener can then be used to select the appropriate (preset) correction information. In such embodiment, it is not necessary to calculate the acoustic field in its entirety to be rendered: Adaptation to a changed position of the at least one listener mainly includes selecting a preset correction information based on the currently tracked position information.

Trinnov Audio has published some very basic mathematical tools to describe, handle and manipulate acoustic fields. Such principles are also very useful with regard to implementing the present invention.

The invention furthermore includes a suggested new audio file format embodied in a computer program product, the audio file comprising:
a number of recording tracks, each recording track having recorded sound originated from one of a plurality of sound sources; and
repeatedly stored positions associated with the sound sources, the stored positions representing a movement profile of the sound sources relative to at least one listening position.

Such audio file may further comprise at least one further recording track having sound originated from a further sound source, wherein the further sound source is not specified regarding its position. The recorded sounds are preferably encoded, and the repeatedly stored positions are metadata associated with the encoded sounds.

### BRIEF DESCRIPTION OF THE DRAWINGS

The invention is described and explained in more detail below on the basis of the exemplary embodiment shown in the figures.

The figures show:

FIG. 1 Basic mathematical tools to describe and manipulate sound fields, as prior art published by Trinnov audio,

FIG. 2 A method for capturing sound originating from a plurality of sound sources according to the invention,

FIG. 3 A computer program product including an audio file according to the invention, and

FIG. 4 A method for playback of recorded sound associated with a plurality of sound sources according to the invention.

### DETAILED DESCRIPTION OF INVENTION

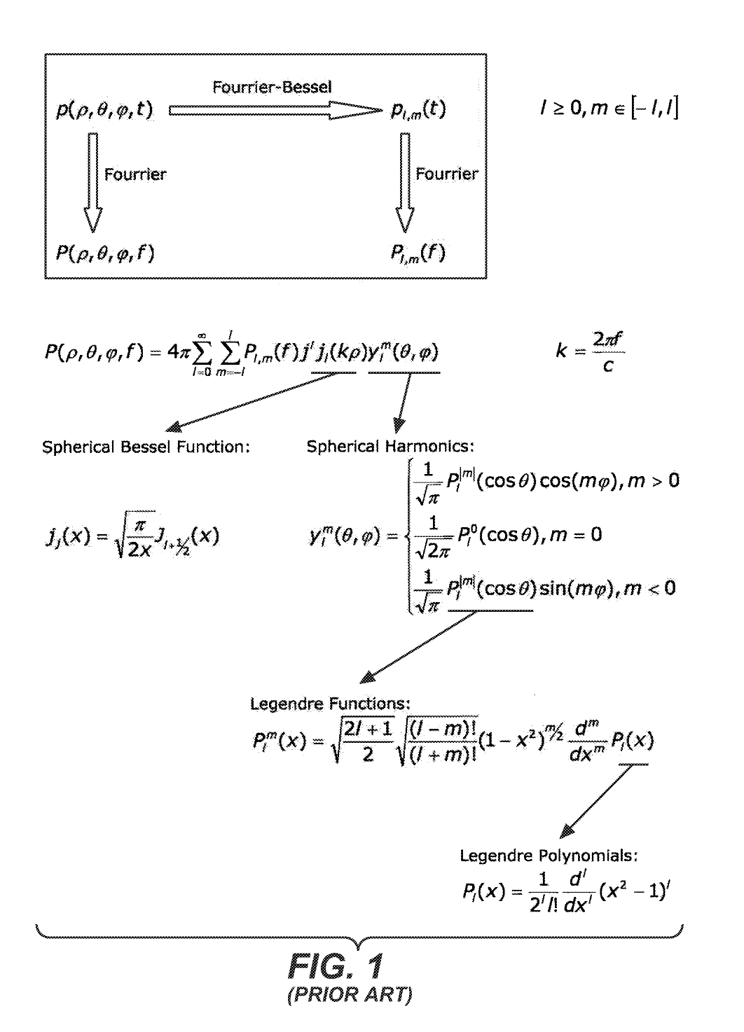

FIG. 1 exhibits basic mathematical formulas and tools to describe, generate and manipulate sound fields according to the prior art. Trinnov Audio have published those formulas and many more related descriptions on their website located at www.trinnov.com. Especially the Research section of said website provides extensive background information useful for application with the present invention.

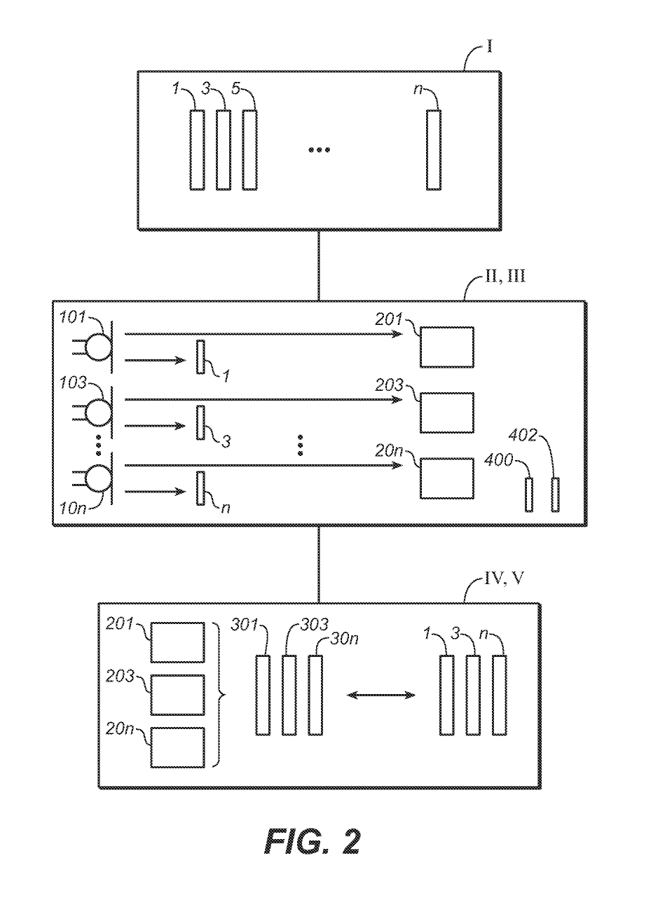

FIG. 2 depicts a principle outline of the method with regard to capturing sound originating from a plurality of sound sources.

Step I includes providing recording tracks 1, 3, 5, . . . , n wherein each recording track shall capture the sound originating from one of the sound sources.

In a step II, the sound originating from each sound source is captured by respective microphones 101, 103, . . . , 10n assigned to the sound sources such that the sound originating from one sound source is recorded on one corresponding individual track 1, 3, . . . n. In FIG. 2, the use of microphones is just exemplary and shall represent any method of receiving and/or creating sound for any sound source including virtual ones like in computer gaming.

In a step III, preferably executed in parallel to step II, the current position 201, 203, . . . 20n of each sound source relative to a (default) listening position is repeatedly determined to obtain a movement profile representing the movements of the sound sources during the recording process. The movement profile can be detected, e.g. via sensor information, and/or it can be generated by prescribing a movement profile, for example in computer gaming scenarios. The default listening position may for example include an ideal and static listening position relative to a multi-speaker surround sound playback system (“sweet spot”) or a headset-based playback system.

In step IV and V, the movement profile including the repeatedly stored positions 201, 203, . . . 20n of each sound source are stored on position tracks and associated with the corresponding recording tracks 1, 3, . . . n such that each recording track has a corresponding stored movement profile regarding the same sound source.

Further recording tracks 400, 402 are provided for capturing sound with no corresponding specific movement profile such as background sound characterizing an environment where for example a movie or gaming scene takes place.

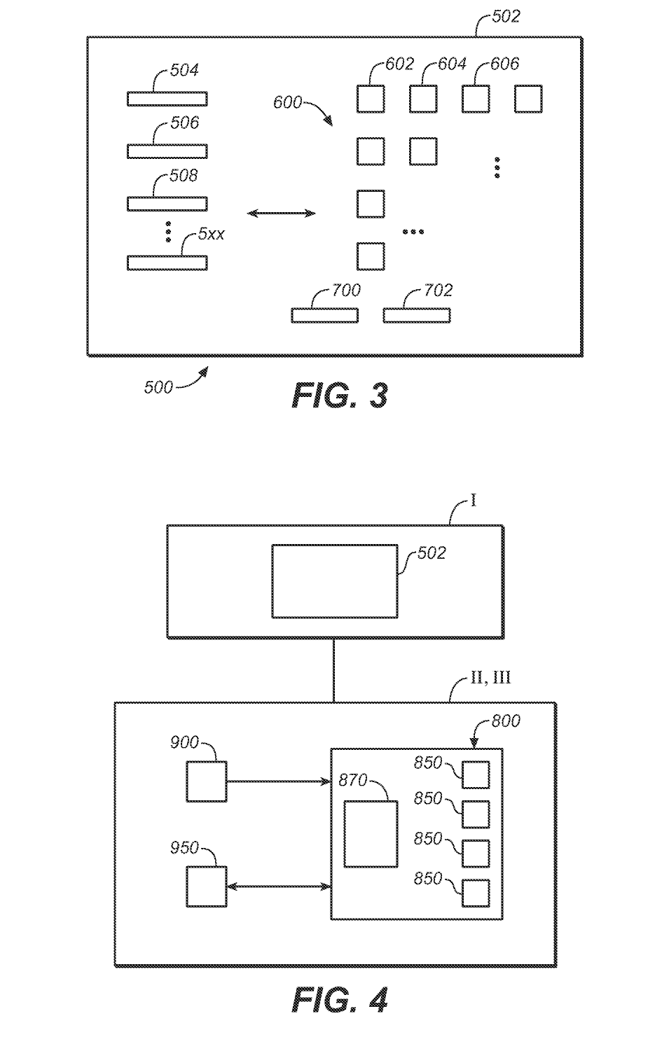

A computer program product including an audio file according to the invention is schematically shown in FIG. 3. The computer program product 500 includes the audio file 502. The latter exhibits recording tracks 504, 506, 508, . . . 5xx each adapted to store sound originating from one of a plurality of sound sources. In order to preserve the spatial distribution of the preferably moving sound sources, the audio file 502 will further include a memory area adapted to store repeatedly acquired positions 602, 604, 606, . . . associated with the sound sources, thus representing a movement profile 600 of the sound sources. Such movement profile preferably relates to at least one listening position as outlined earlier. Further tracks 700, 702 may be provided to store sound from further sound sources having no specific movement profile and/or position.

FIG. 4 schematically depicts a method for playback of recorded sound originating from a plurality of sound sources according to the invention.

In a first step I, an audio file 502—such as depicted in FIG. 3—is provided. The audio file 502 holds on each of its recording tracks the sound captured from one of a plurality of sound sources. The movement of the sound sources relative to at least one listening position is captured in a movement profile and also stored on the audio file.

In a step II, an audio playback system 800 including a number of playback channels 850 is provided. The playback system 800 is specifically adapted to receive and playback the audio file 502 by having a computing unit 870 to generate a spatial audio field based on the recording tracks and the movement profile. Generation of the audio field is hereby adapted to the type and number of playback channels 850.

Furthermore, a position tracking sensor 900 is provided to repeatedly—e.g. quasi-continuously—track a current position of at least one listener during playback. The computing unit 870 then uses such position data of the listener(s) to adapt the spatial audio field to the current position of the listener such that not only the movement of the sound sources but also the movement of the listener during playback is properly taken into consideration when rendering the acoustic field in a step III. The position tracking sensor 900 can also be capable of tracking the position of a number of listeners in parallel. Then, individual acoustic fields tailored to the individual listeners can be generated and delivered to the respective listener, preferably via an audio headset or, preferably if one individual acoustic field is tailored to a group of listeners, via a fixed-channel loudspeaker arrangement.

A pre-determined listener position correction matrix 950 holds various presets of the spatial acoustic field, each preset adapted to one specific position of the listener in the listening environment. Using the currently determined position of the at least one listener, the corresponding preset acoustic field is selected from the position correction matrix 950 and rendered to the listener(s).

To briefly summarize, the invention as outlined is capable of providing the audience with dynamic surround sound that can be tailored to one or more listeners based upon their location and motion. It may leverage existing technology to create a more immersive and interactive surround sound experience: If, for example, two players are playing a tennis video game in the same room, when player 1 hits the ball, the sound of the racket hitting the ball would appear to player 2 to come from where player 1 is currently located (e.g. behind him, to the right). Another example is if one person is listening to two-channel music, he or she will hear the full sound stage with proper stereo imaging no matter where he or she decides to sit in the room.

Utilizing existing open source APIs, a real-time three-dimensional location matrix may identify the location of listeners/players/users in a room. Such position matrix may depict the three dimensions as each a continuum of top/bottom, left/right, and depth. A snapshot of the location information is repeatedly taken, pausing briefly, and then taking a subsequent snapshot. After comparing snapshots, the area of the matrix with the greatest difference in location values indicates the greatest movement and the location of user(s) in the (listening/gaming) room. The speaker output is then automatically adjusted in accordance with the matrixed location of the user(s) in the room. This can be done e.g. by creating presets of spatial fields corresponding to each possible location of the user in the room and recalling the appropriate preset as the listener moves.

A person skilled in the art will easily be able to apply the various concepts outlined above to reach further embodiments of the invention.

1-14. (canceled)

15. A method for playback of recorded sound associated with a plurality of sound sources, the method comprising:
providing an audio file, wherein the audio file comprises:
a number of recording tracks, each recording track having recorded sound originated from one of the sound sources, and repeatedly stored positions associated with the sound sources, each stored position representing a current position of one of the sound sources relative to at least one listening position;
providing an audio playback system including a number of playback channels, wherein the playback system includes a computing unit programmed to generate a spatial acoustic field based on the recorded sounds and repeatedly stored positions included in the audio file; and
playback of the spatial acoustic field on the audio playback system.

16. The method according to claim 15, wherein generating the spatial acoustic field is adapted to the number of the playback channels during playback.

17. The method according to claim 15, further comprising providing a sensor adapted to track a current position of at least one listener.

18. The method according to claim 17, wherein generating the spatial acoustic field includes adapting the repeatedly stored positions to the tracked current position of the at least one listener to compensate for a movement of the respective listener relative to the at least one listening position.

19. The method according to claim 18, wherein adapting the repeatedly stored positions to the tracked position of the at least one listener is based on selecting correction information from a previously stored correction information matrix, the selected correction information associated with the tracked position of the at least one listener.

20. The method according to claim 19, wherein the previously stored correction information matrix includes previously stored correction information related to a number of possible positions of the listener.

21. The method of claim 15, wherein the stored positions are metadata associated with the respective sound source.

22. The method of claim 15, wherein the spatial acoustic field is rendered from moving sound sources instead of fixed channels, and
the computing unit generates the spatial acoustic field by utilizing a dynamically generated matrix representing transfer functions between moving sound sources and the acoustic field, the transfer functions also including a current position of at least one listener, wherein the current position of the at least one listener is tracked by a sensor.

23. The method of claim 22, wherein the stored positions are metadata associated with the respective sound source.

24. The method of claim 15, wherein
a current position of at least one listener is tracked by a sensor,
generating the spatial acoustic field by the computing unit includes selecting a preset acoustic field from a number of preset acoustic fields based on the current position of the at least one listener, and
the selected preset acoustic field is played back on the audio playback system as the spatial acoustic field.

25. The method of claim 24, wherein the stored positions are metadata associated with the respective sound source.

26. The method of claim 15, wherein
a position of a number of listeners is tracked in parallel,
generating the spatial acoustic field by the computing unit includes generating individual acoustic fields tailored to the respective tracked positions of the listeners, and
playback of the spatial acoustic field includes rendering the individual acoustic fields to the listeners.

27. The method of claim 26, wherein the stored positions are metadata associated with the respective sound source.
